(19) United States
(12) Patent Application Publication
(10) Pub. No.: US 2010/0256260 A1
(43) Pub. Date: Oct. 7, 2010

(54) Polymer Encapsulated Pigments

(76) Inventors: Hui Liu, San Diego, CA (US); Phillip C. Cagle, San Marcos, CA (US); David Michael Ingle, San Diego, CA (US)

Correspondence Address: HEWLETT-PACKARD COMPANY;Intellectual Property Administration, 3404 E. Harmony Road, Mail Stop 35, FORT COLLINS, CO, 80528, US

(21) Appl. No.: 12/743,362

(22) PCT Filed: Nov. 15, 2007
(86) PCT No.: PCT/US07/24099

§ 371 Date: May 17, 2010

(51) Int. Cl. C09D 11/10; C09B 67/22

(52) U.S. Cl. 523/206; 524/502

(57) ABSTRACT

The present invention is drawn to an encapsulated pigment. The pigment can be encapsulated by both a first polymer layer and a second polymer layer, with the second polymer layer encapsulating the first polymer layer and/or the pigment. The first polymer layer can have less than 2 wt % polymerized acid monomer. The second polymer layer is more hydrophilic than the first polymer layer, and is present at a weight ratio of first polymer layer to second polymer layer of greater than about 1.5:1. Methods of forming an encapsulated pigment are also presented.

### BACKGROUND OF THE INVENTION

In ink-jet ink chemistry, the majority of commercial ink-jet inks are water-based. Thus, their constituents are generally water-soluble, as in the case with many dyes, or water dispersible, as in the case with pigments. Polymer-encapsulated pigments of various kinds are known. However, the polymer chemistries of these pigments are typically incompatible or ineffective for use with many ink-jet inks and printheads. For example, many are not suitable for use in thermal ink-jet printheads. Such compositions tend to either agglomerate under the high thermal shear conditions of the pen firing chamber, causing nozzle and ink channel blockages, or have excessive glass transition temperatures that prevent room temperature print film formation. Thus, incorporation of such polymer encapsulated pigments within thermal ink-jet inks can result in pen unreliability or poor print durability colorant performance. Further, some polymer-encapsulated pigments release at least a portion of the encapsulating material into the surrounding aqueous phase, unintentionally altering the chemical and physical properties of the ink. Such is the case often with encapsulating polymers that include an acid. Ultimately, polymer encapsulated pigments are often formulated to balance the desirable qualities of the pigment against undesirable characteristics. For example, stability, durability, and reliability of the pigment are often at odds with each other. If an encapsulated pigment particle is optimized for durability, it typically exhibits poor firing performance. Likewise, encapsulated pigment particles optimized for firing are often unstable in solution.

### DETAILED DESCRIPTION OF THE PREFERRED EMBODIMENT(S)

Before the present invention is disclosed and described, it is to be understood that this invention is not limited to the particular process steps and materials disclosed herein because such process steps and materials may vary materials disclosed herein because such process steps and materials may vary somewhat. It is also to be understood that the terminology used herein is used for the purpose of describing particular embodiments only. The terms are not intended to be limiting because the scope of the present invention is intended to be limited only by the appended claims and equivalents thereof.

It is noted that, as used in this specification and the appended claims, the singular forms “a,” “an,” and “the” include plural referents unless the context clearly dictates otherwise.

As used herein, “liquid vehicle” refers to a liquid in which pigment particles are dispersed. Liquid vehicles are well known in the art, and a wide variety of liquid vehicles may be used in accordance with embodiments of the present invention. Such liquid vehicles may include a mixture of a variety of different agents, including without limitation, surfactants, solvents, co-solvents, buffers, biocides, viscosity modifiers, sequestering agents, stabilizing agents, and/or water.

The term “layer” is defined specifically to include compositions of various characteristics and appearances. For example, a layer may be a composition that is adsorbed, chemically reacted, or otherwise applied to a surface of another material. Such layers can be complete, substantially complete, or incomplete, i.e. including discontinuous areas or regions. Further, the discussion of a first layer and a second layer does not necessarily infer that such materials are applied on top of one another, e.g., both can be applied to a common substrate. In some embodiments, however, layers can be applied over one another to form a multiple layered structure.

As used herein, “plurality” refers to more than one. For example, a plurality of monomers refers to at least two monomers.

As used herein, the term “about” is used to provide flexibility to a numerical range endpoint by providing that a given value may be “a little above” or “a little below” the endpoint. The degree of flexibility of this term can be dictated by the particular variable and would be within the knowledge of those skilled in the art to determine based on experience and the associated description herein.

The term “substantially free” refers to the total absence of or near total absence of a specific compound or composition. For example, when a composition is said to be substantially free of acid, there is either no acid in the composition or only trace amounts of acid in the composition. Likewise, the term “substantially” refers to the complete or nearly complete extent or degree of an action, characteristic, property, state, structure, item, or result. The exact allowable degree of deviation from absolute completeness may in some cases depend on the specific context. However, generally speaking, the nearness of completion will be so as to have the same or similar overall result as if absolute and total completion were obtained.

“Pigment” can include color-imparting particulates and other substance that may be suspended or solvated in a liquid vehicle.

As used herein, a plurality of items, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

Concentrations, amounts, and other numerical data may be expressed or presented herein in a range format. It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a concentration range of “0.1 wt % to 5 wt %” should be interpreted to include not only the explicitly recited concentration of 0.1 wt % to 5 wt %, but also include individual concentrations and the sub-ranges within the indicated range. Thus, included in this numerical range are individual concentrations, such as 1 wt %, 2 wt %, 3 wt %, and 4 wt %, and sub-ranges, such as from 0.1 wt % to 1.5 wt %, 1 wt % to 3 wt %, from 2 wt % to 4 wt %, from 3 wt % to 5 wt %, etc. This same principle applies to ranges reciting only one numerical value. For example, a range recited as “less than 5 wt %” should be interpreted to include all values and sub-ranges between 0 wt % and 5 wt %. Furthermore, such an interpretation should apply regardless of the breadth of the range or the characteristics being described.

With these definitions in mind, an encapsulated pigment is presented. The encapsulated pigment can include a pigment and at least two layers of polymer. A first polymer layer can encapsulate the pigment. A second polymer layer can encapsulate the first polymer layer, and likewise the pigment. The second polymer layer can be more hydrophilic than the first polymer layer and can be present at a weight ratio of the first polymer layer to the second polymer layer of greater than about 1.5:1. The first polymer layer can have less than 2 wt % polymerized acid monomer. The encapsulated pigment can have a particle size of less than about 500 nm. Additionally, a method of making an encapsulated pigment can include dispersing a pigment in an aqueous medium, polymerizing a first group of monomers in the aqueous medium to create a first polymer layer, and polymerizing a second group of monomers, different and distinct from the first group, to create a second polymer layer. The first layer can encapsulate the pigment and can include less than 2 wt % of acidic monomers, and the second layer can encapsulate both the pigment and the first layer and can include at least 2 wt % of acidic monomers. Alternatively, another method of making an encapsulated pigment can include first forming an outer polymeric composition, such as the second composition, and then introducing a hydrophobic, as compared to the second composition, inner composition which can migrate through the outer polymeric composition and form an inner composition of material, similar to the first composition. Such migration can be facilitated by kinetic or thermodynamic mechanisms. An encapsulated pigment prepared according to this method can exhibit desirable properties such as, e.g., increased, and retained, surface acid, and greater stability. It is noted that these layers can substantially encapsulate the pigment or layer to which each layer is applied, or can partially encapsulate the pigment or layer to which each layer is applied.

In accordance with the invention embodiments outlined, various details are provided herein which are applicable to each of the encapsulated pigment, pigment dispersion, ink-jet ink, and methods for making the encapsulated pigment, dispersion, and ink-jet ink. Thus, discussion of one specific embodiment is related to and provides support for this discussion in the context of the other related embodiments.

As noted, a method of making an encapsulated pigment can include a number of steps. A pigment can be at least twice encapsulated. More specifically, a pigment can be encapsulated by at least two distinct layers of polymer. Such encapsulation can be a result of polymerization of two distinct groups of monomers in two separate or nearly-separate steps, thus creating a pigment encapsulated twice by distinct polymer layers. Encapsulation layers can each independently be partial to complete. Such encapsulation allows for greater control over the physical properties of the pigment, as well as location and amount of components in the polymer layers, and ultimately, the polymer layers can be selected and created to produce an encapsulated pigment having greater stability in solution and less acidic group loss to solution than other encapsulated pigments.

In one aspect, a method of making an encapsulated pigment can include dispersing a pigment in an aqueous medium. A single pigment type can be dispersed, or alternatively, a plurality of pigment types can be dispersed in the aqueous medium. Such pigment dispersions can be pre-dispersed or ready-made. Thus, it may or may not be desirable to add additional liquid vehicle to the dispersion. Therefore, dispersing pigment particles in a liquid vehicle can, in some cases, include purchasing and using a dispersion that includes pigment particles. Regardless of the source of the dispersion, in one aspect, additional components can be included in the dispersion, such as surfactants and dispersing agents. When a plurality of monomers, referred to as first-layer monomers, is present in the aqueous medium, they can be polymerized to form a first polymer layer. The first polymer layer can substantially encapsulate the pigment.

The method can further include dispersing a plurality of second-layer monomers in the aqueous medium. The second-layer monomers are compositionally distinct and different from the first-layer monomers, and particularly, include at least one monomer that is different than the first-layer monomers. In some embodiments, the first layer monomers are completely different than the second-layer monomers. As with the first-layer monomer term, the second-layer monomer term is used only for ease of discussion and is not intended to infer anything beyond monomers used to form a polymer layer around a polymer-encapsulated pigment. Polymerizing the second-layer monomers on a surface of the first polymer layer creates a second polymer layer that encapsulates the pigment and the first polymer layer.

Dispersing either or both of the first- or second-layer monomers in the aqueous medium can include forming an emulsion of a plurality of monomers in an aqueous solution by high energy dispersing methods. In a specific embodiment, the emulsion can be a conventional emulsion or alternatively, a mini-emulsion. Non-limiting examples of such high energy dispersing methods include sonication, micro-fluidization, and high-pressure homogenization. In a specific embodiment, the high energy dispersing method can include sonication. Once an emulsion is formed, it can be added to the pigment dispersion, or the pigment dispersion can be added to the emulsion. Furthermore, once the monomer and pigments are combined, the mixture can be reprocessed through dispersing equipment again for any number of iterations. Similarly, with an emulsion of a second-layer monomer, the emulsion can be added to the encapsulated pigment dispersion (where the pigment is encapsulated with a first polymer layer), or the encapsulated pigment can be added to the emulsion of second-layer monomers. It is noted that once the monomers and pigments are combined, the mixture can be reprocessed through dispersing equipment again. The polymerization of each layer can occur in a near-batch or semi-continuous process. For example, there can be a definite point in the process after a first polymer layer is formed around the pigment, and prior to polymerization of a second polymer layer. As such, the batch process reflects two separate polymerization reactions. Alternatively, a semi-continuous method can be used wherein a pigment dispersion is charged in a reactor, and monomer preemulsions are fed sequentially into the pigment dispersion, without a definite break in forming the first layer polymer and forming the second layer polymer. In one aspect, the process can provide a definite break between forming the first composition polymer and forming the second composition monomer. In this case, it can be desirable for most residual monomers from the first composition to be substantially reacted prior to the introduction of the second monomer sequence to minimize unintentionally creating a polymer of indeterminate composition somewhat between the first and second compositions. It is noted that in one embodiment, the two separate layers are not formed by causing incremental changes in a continuous polymerization process, but rather, the formation of the polymer encapsulated pigments is defined by the formation of two separate and definable layers.

Causing monomers to polymerize on the surface of a pigment and surface of a first or subsequent polymer encapsulation layer can be done in any manner known in the art. In one aspect, the surface of the pigment can be charged. In an alternate aspect, the pigment can be uncharged.

In a further embodiment, a pigment can be encapsulated by more than two polymer layers. As such, a method for producing a polymer encapsulated pigment having more than two polymer layers can include dispersing a plurality of third-layer monomers in the aqueous medium. The third-layer monomers can be compositionally different from the second-layer monomers. The relation of the third-layer monomers to the first-layer monomers can be compositionally different, or compositionally the same. The third-layer monomers can be polymerized on a surface of the second polymer layer to create a third polymer layer that substantially encapsulates the second polymer layer, and thus, the first polymer layer and the pigment.

More than three layers can be created by following the same approach. The number and type of polymer layers, and thus selection of type and amount of monomers, can be determined by desired use. One consideration that can take place when creating encapsulated pigments is the final molecular weight and size of the particle. By forming a plurality of encapsulation layers, the particle mass of the encapsulated pigment is naturally greater than that of the pigment itself, and may, depending on the size of each encapsulation layer, have a greater particle mass than many single-layer encapsulated pigments.

First- and second-layer monomers should be compositionally different, however, can both include, in each respective composition, one or more of the same monomers. The monomers can either separately or both be selected from a single different monomer for one or both layer(s) or each can be a mixture of monomers. The monomers used by the present method to encapsulate a pigment particulate can be any monomer presently known in the art. In one embodiment, a monomer selected for an encapsulation layer can comprise or consist essentially of an acrylate, a methacrylate, or other vinyl-containing monomers such as styrene. Non-limiting examples of monomers include methyl methacrylate, methyl acrylate, ethyl methacrylate, ethyl acrylate, butyl methacrylate, butyl acrylate, hexyl methacrylate, 2-ethylhexyl methacrylate, 2-ethylhexyl acrylate, isobutyl methacrylate, isobutyl acrylate, octyl methacrylate, lauryl methacrylate, dodecyl methacrylate, methacrylic acid, hydroxylethyl acrylate, styrene, cyclohexyl methacrylate, cyclohexyl acrylate, isobornyl methacrylate, isobornyl acrylate, stearyl methacrylate, stearyl acrylate, di-functional/multi-functional acrylate/methacrylate/vinyl monomers, and mixtures thereof. An encapsulated pigment created according to the methods defined herein includes a pigment, a first polymer layer that encapsulates the pigment, and a second polymer layer that encapsulates the first polymer layer, and therefore also encapsulates the pigment. The first polymer layer and the second polymer layer can be selected to coordinate with one another as it relates to a given application or as it relates to the ability to generate layers that are compatible with one another. In one aspect, the second-layer monomers can be selected based on first-layer monomers and the amount used for the encapsulation process. Selection of both the monomers for each polymer layer, and amount used (thus thickness of the resulting polymer layer), can alter the final properties of the encapsulated pigment. In a specific embodiment, the second polymer layer can be more hydrophilic than the first polymer layer. Such arrangement allows for greater stability in aqueous systems.

Various weight ratios are contemplated by the present design. In one aspect, the weight ratio of the first polymer layer to the second polymer layer can be greater than about 1.5:1. In another embodiment, the weight ratio can be greater than about 2.5:1. Such weight ratios can indicate an often larger, or thicker, first polymer layer, with a thinner polymer layer on the outer portion of the encapsulated pigment. In a specific embodiment, the weight ratio of the first polymer layer to the second polymer layer can be greater than about 1.5:1, and the second polymer layer can be more hydrophilic than the first polymer layer. In one aspect, the encapsulated pigment can have a particle size of less than about 500 nm, or less than about 300 nm.

In one aspect, one or both of the polymer layers can include cross-linking. In a specific embodiment, the first polymer layer can include cross-linking. In another aspect, a chain transfer agent can be included in one or more of the polymer compositions. In a specific embodiment, the second polymer composition can include chain transfer agents.

When selecting the amount and types of monomers to use for each polymer layer, often it is desirable to improve physical properties of the encapsulated pigment, such as durability, jettability, printability, and/or stability. Typically, these properties are inversely related to some degree, meaning that improving one naturally decreases the functionality of at least one of the others. In some configurations of the encapsulated pigment herein, however, it is possible to improve many or even all of the noted properties, thus providing a much-improved encapsulated pigment.

Acid concentration in a polymer layer can improve firing performance and stability of a pigment in aqueous-based solutions. The acid is typically most useful when located closest to the surface of an encapsulated pigment, e.g., at the interface between the particle and the environment, e.g. liquid medium. Typically, high acid concentrations in the encapsulation material can lead to significantly increased levels of acid-containing oligomers and polymers in the aqueous phase. In the case of an ink, the increase of acid in the liquid vehicle can greatly alter the ink properties, and can affect the usefulness of the ink components and/or ink as a whole.

However, the encapsulated pigments described herein can be configured to include acid content in a lower amount, but nearer to the surface, thus reducing the amount of acid that can lead to increased water phase polymeric acid, while maintaining or improving upon the benefits of including acid throughout the encapsulation polymer. In a specific embodiment, the bulk of the acid can be present in the second or outermost encapsulation layer. Further, in one embodiment, the first polymer layer can include less than 2 wt % polymerized acid monomer. In still a further embodiment, the first polymer layer can be substantially free of acid. While acid is not preferred for presence on the inner or first polymer layer, it can be present, and more particularly, it is desirable to include acid in the outer or second polymer layer. In one embodiment, the encapsulated pigment can have a second polymer layer with at least 2 wt % polymerized acid monomer. In additional embodiments, the encapsulated pigment can have a second polymer layer with greater than about 5 wt % polymerized acid monomer, and even greater than about 8 wt % polymerized acid monomer. In another aspect, such second composition acid concentration can be a calculated value. In still another embodiment where the encapsulated pigment has greater than about 5 wt % of acidic polymerized monomers in the second polymer layer, and the aqueous medium can contain less than 2 wt % acid in the aqueous medium. Additionally, where the acid is included primarily or solely in the second polymer layer, the overall amount of acid in the encapsulating polymer can be reduced. As a result, the amount of acid that detaches or dissolves into the aqueous phase will be reduced, which in turn leads to improved long-term stability. As such, both jettability and stability are simultaneously improved.

In another embodiment, the first-layer monomers can include substantially no hydrophilic monomers, while the second-layer monomers include a high concentration of hydrophilic monomers. Non-limiting examples of hydrophilic monomers include hydroxyethylacrylate (HEA), hydroxylethyl methacrylate, and acrylamides. In a specific embodiment, HEA can be included in the encapsulating monomers used to form the second or outermost polymer layer. The hydrophilic nature of HEA provides improved dispersing and jetting, however it can be difficult to work with as it increases the difficulty of drying the ink. When used in the present encapsulation configuration, the overall content of HEA can be reduced, while including HEA in the second-layer monomers. When used as a second-layer monomers, and devoid or present in a minimal amount in the first-layer monomers, the HEA improves dispersing and jetting, while minimally, if at all, affecting the ink drying.

In still another embodiment, the first polymer layer can have a glass transition temperature (T_{g}) less than the T_{g} of the second polymer layer. It has been shown that high T_{g} latex particles are easier to jet, while latex particles having a lower T_{g} are softer and are prone to foul resistors and cause printing problems. However, latex particles having a high T_{g} have low adhesion to media and have a difficult time forming a film without excessive heating. By selecting monomers to encapsulate a pigment in multiple layers such that the first polymer layer has a T_{g} less than the T_{g} of the second polymer layer, the benefits of jetting hard particles can be retained, and the problem of film formation and adhesion can be minimized due to the presence of the first polymer layer having a lower T_{g}. In a specific embodiment, the T_{g} of the first polymer layer can be from about 0° C. to about 105° C., and/or the second polymer layer can have a T_{g} from about 75° C. to about 125° C.

Alternatively, another method of making an encapsulated pigment can include first forming an outer polymeric composition, such as the second composition, and then introducing a hydrophobic, as compared to the second composition, inner composition which can migrate through the outer polymeric composition and form an inner composition of material, similar to the first composition. Such migration can be facilitated by kinetic or thermodynamic mechanisms.

As previously mentioned, the encapsulated pigment can be included in an ink. In a specific embodiment, an ink-jet ink can include encapsulated pigments or a plurality of encapsulated pigments and/or other pigments dispersed in a liquid vehicle. In one aspect, the ink-jet ink can be configured for use in thermal ink-jet architecture.

Typical liquid vehicle formulations that can be used with the encapsulated pigments described herein can include water, and optionally, one or more co-solvents. Further, one or more non-ionic, cationic, and/or anionic surfactants can be present. The balance of the formulation can be purified water, or other vehicle components known in the art, such as biocides, viscosity modifiers, materials for pH adjustment, sequestering agents, preservatives, and the like. Typically, the liquid vehicle is predominantly water.

Non-limiting examples of classes of co-solvents that can be used can include aliphatic alcohols, aromatic alcohols, diols, glycol ethers, polyglycol ethers, caprolactams, formamides, acetamides, and long chain alcohols. Examples of such compounds include primary aliphatic alcohols, secondary aliphatic alcohols, 1,2-alcohols, 1,3-alcohols, 1,5-alcohols, ethylene glycol alkyl ethers, propylene glycol alkyl ethers, higher homologs of polyethylene glycol alkyl ethers, N-alkyl caprolactams, unsubstituted caprolactams, both substituted and unsubstituted formamides, both substituted and unsubstituted acetamides, and the like. Specific examples of solvents that can be used include trimethylolpropane, 2-pyrrolidinone, and 1,5-pentanediol.

One or more of many surfactants can also be used. Such surfactants can include non-ionic, amphoteric, anionic, and cationic surfactants. Such surfactants are known by those skilled in the art of ink formulation and may include alkyl polyethylene oxides, alkyl phenyl polyethylene oxides, polyethylene oxide block copolymers, acetylenic polyethylene oxides, polyethylene oxide (di)esters, polyethylene oxide amines, protonated polyethylene oxide amines, protonated polyethylene oxide amides, dimethicone copolyols, substituted amine oxides, and the like.

Consistent with the methods of this invention, various other additives may be employed to optimize the properties of the ink composition for specific applications. Examples of these additives are those added to inhibit the growth of harmful microorganisms. These additives may be biocides, fungicides, and other microbial agents, which are routinely used in ink formulations.

Sequestering agents, such as EDTA (ethylene diamine tetra acetic acid), may be included to eliminate the deleterious effects of heavy metal impurities, and buffer solutions may be used to control the pH of the ink. If present, from 0.01 wt % to 2 wt %, for example, can be used. Viscosity modifiers and buffers may also be present, as well as other additives known to those skilled in the art to modify properties of the ink as desired. If present, such additives can be included at from 0.01 wt % to 20 wt %.

The ink-jet inks made according to the methods herein can generally provide several advantages. For example, the use of polymer encapsulated pigments tends to reduce the number of total particles in solution (as opposed to having separate latex particulates co-dispersed with the pigments) and their combined surface areas such that the pigment suspension, e.g., ink, viscosity can be reduced. Encapsulation also prevents pigment-latex separation when applied to a substrate, e.g., ink printed on a media substrate, such that durability and optical density are more optimized. Polymer-encapsulated pigments also facilitate the result that each or the majority of pigment particle becomes trapped below the surface of latex formed films (after printing) such that gloss and color-to-color gloss uniformity is enhanced.

### EXAMPLES

The following examples illustrate embodiments of the invention that are presently known. Thus, these examples should not be considered as limitations of the present invention, but are merely in place to teach how to make the best-known compositions of the present invention based upon current experimental data. As such, a representative number of compositions and their method of manufacture are disclosed herein.

### Example 1

### Multi-Layered Polymer-Encapsulated Pigment

To a 250 ml 3-neck round-bottomed flask equipped with overhead paddle stirrer, thermocouple probe, and condenser is added a dispersion of Pigment Yellow 213 (10 g), sodium dodecylsulfate (1.75 g), and water (179.25 g). The flask is stirred at 200 rpm and heated toward 82° C. Meanwhile, a monomer emulsion is made by vigorously mixing methyl methacrylate (6 g), butyl acrylate (2 g), Abex® EP120 (0.264 g), Triton® X-305 (0.16 g), Aerosol® OT-75 (0.1 g), and water (2 g) for 30 minutes. As the reaction vessel reaches 77° C., potassium persulfate (0.4 g) is added and the monomer emulsion is fed to the reaction mixture over 160 minutes. Immediately after the monomer feed is complete, a second monomer emulsion (made by similar procedure but consisting of methyl methacrylate (1.5 g), butyl acrylate (0.5 g), methacrylic acid (0.2 g), Abex® EP120 (0.066 g), Triton® X-305 (0.04 g), Aerosol® OT-75 (0.026 g), and water (0.5 g)) is fed to the reaction mixture over 60 minutes. The reaction temperature is held at 82° C. throughout the feeds and for one hour after the final monomer feed is complete. The reaction is then cooled and filtered through a 1-micron filter. The reaction product has 5 wt % pigment (as measured by UV-vis) and 5 wt % encapsulating polymer.

### Example 2

### Multi-Layered Polymer-Encapsulated Pigment

To a 250 ml 3-neck round-bottomed flask equipped with overhead paddle stirrer, thermocouple probe and condenser is added a dispersion of Pigment Yellow 213 (10 g), sodium dodecylsulfate (1.75 g), and water (179.25 g). The flask is stirred at 200 rpm and heated toward 82° C. Meanwhile, a monomer emulsion is made by vigorously mixing methyl methacrylate (6 g), butyl acrylate (2 g), Abex® EP120 (0.264 g), Triton® X-305 (0.16 g), Aerosol® OT-75 (0.1 g), and water (2 g) for 30 minutes. As the reaction vessel reaches 77° C., potassium persulfate (0.4 g) is added and the monomer emulsion is fed to the reaction mixture over 160 minutes. Immediately after the monomer feed is complete, a second monomer emulsion (made by similar procedure but consisting of methyl methacrylate (1.5 g), butyl acrylate (0.5 g), methacrylic acid (0.3 g), Abex® EP120 (0.066 g), Triton® X-305 (0.04 g), Aerosol® OT-75 (0.026 g), and water (0.5 g)) is fed to the reaction mixture over 60 minutes. The reaction temperature is held at 82° C. throughout the feeds and for one hour after the final monomer feed is complete. The reaction is then cooled and filtered through a 1-micron filter. The reaction product has 5 wt % pigment (as measured by UV-vis) and 5 wt % encapsulating polymer, with solids content of 10.2 wt %.

### Example 3

### Comparison Example

To a 250 ml 3-neck round-bottomed flask equipped with overhead paddle stirrer, thermocouple probe and condenser is added a dispersion of Pigment Yellow 213 (10 g), sodium dodecylsulfate (1.75 g), and water (179.25 g). The flask is stirred at 200 rpm and heated toward 82° C. Meanwhile, a monomer emulsion is made by vigorously mixing methyl methacrylate (7.5 g), butyl acrylate (2.5 g), methacrylic acid (1 g), Abex® EP120 (0.33 g), Triton® X-305 (0.2 g), Aerosol® OT-75 (0.13 g), and water (2.5 g) for 30 minutes. As the reaction vessel reaches 77° C., potassium persulfate (0.4 g) is added and the monomer emulsion is fed to the reaction mixture over 200 minutes. The reaction temperature is held at 82° C. for one hour after the monomer feed is complete. The reaction is then cooled and filtered through a 1-micron filter. The reaction product has 5 wt % pigment (as measured by UV-vis) and 5 wt % encapsulating polymer.

### Example 4

### Comparison Example

The following materials are combined in a 250 ml beaker: methyl methacrylate (7.5 g), butyl acrylate (2.5 g), methacrylic acid (0.1 g), hexadecane (0.5 g), sodium dodecylsulfate (0.8 g), and water (88.7 g). The mixture is stirred by magnetic stirrer for 30 minutes to mix well. A mini-emulsion is made by sonicating 2 minutes at maximum power using a Heat Systems® Ultrasonic Processor with Model CL4 Ultrasonic Converter. To this is added a dispersion of Pigment Yellow 213 (10 g), sodium dodecylsulfate (1.75 g), and water (88.25 g). This mixture is then sonicated 2 minutes at maximum power. This monomer/pigment mixture is then added to a 250 ml 3-neck round-bottomed flask equipped with overhead paddle stirrer, thermocouple probe and condenser. The flask is stirred at 200 rpm, and 0.95 g Aerosol® OT-75 is added. The flask is heated to 82° C. At 77° C., 0.2 g potassium persulfate is added and the reaction is held at 82° C. for 4-5 hours. The product is then cooled and filtered through a 1-micron filter. The reaction product has 5 wt % pigment (as measured by UV-vis) and 5 wt % encapsulating polymer, with a solids content of 10.6 wt %. The particle size is about D₅₀ 0.11μ.

### Example 5

### Comparison Example

The following materials are combined in a 250 ml beaker: methyl methacrylate (7.5 g), butyl acrylate (2.5 g), methacrylic acid (0.3 g), hexadecane (0.5 g), sodium dodecylsulfate (0.8 g), and water (88.7 g). The mixture is stirred by magnetic stirrer for 30 minutes to mix well. A mini-emulsion is made by sonicating 2 minutes at maximum power using a Heat Systems® Ultrasonic Processor with Model CL4 Ultrasonic Converter, To this is added a dispersion of Pigment Yellow 213 (10 g), sodium dodecylsulfate (1.75 g), and water (88.25 g), which is then sonicated 2 minutes at maximum power. This monomer/pigment mixture is added to a 3-neck round-bottomed flask equipped with overhead paddle stirrer, thermocouple probe and condenser. The flask is stirred at 200 rpm and 0.95 g dioctyl sulfosuccinate is added. The flask is heated to 82° C., and at 77° C., 0.2 g potassium persulfate is added. The reaction is held at 82° C. for 4-5 hours. The product is then cooled and filtered through a 1-micron filter. The reaction product has 5 wt % pigment (as measured by UV-vis) and 5 wt % encapsulating polymer, with a solids content of 10.6 wt % and a particle size of D₅₀ 0.11μ.

### Example 6

### Comparison of Acid Content in Single and Multi-Layered Encapsulated

Pigments

Five encapsulated pigments were prepared and analyzed in accordance with Examples 1-5.

| | No. of layers of | | Acid partitioning | Surface |
|---|---|---|---|---|
| Batch | polymer | Acid in | into aqueous | acid |
| Example | encapsulation | encapsulate | phase | density |
| 1 | 2 | 1^{st} layer - 0% | 0.8% | 10% |
| | (weight ratio | 2^{nd} layer - 2% | | |
| | 1^{st}:2^{nd} = 8:2) | | | |
| 2 | 2 | 1^{st} layer - 0% | 1.2% | 15% |
| | (weight ratio | 2^{nd} layer - 3% | | |
| | 1^{st}:2^{nd} = 8:2) | | | |
| 3 | 1 | 10% | 4% | 10% |
| 4 | 1 | 1% | 0.4% | 1% |
| 5 | 1 | 3% | 1.2% | 3% |

As illustrated, the dual-encapsulated pigments of batches 1 and 2 include lesser amounts of total acid content, and thus, less acid partitioning occurs, e.g., less acid enters the aqueous phase relative to the surface acid density that is achieved.

While the invention has been described with reference to certain preferred embodiments, those skilled in the art will appreciate that various modifications, changes, omissions, and substitutions can be made without departing from the spirit of the invention. It is intended, therefore, that the invention be limited only by the scope of the following claims.

What is claimed is:

1. An encapsulated pigment, comprising:
a pigment;
a first polymer layer encapsulating the pigment, said first polymer layer having less than 2 wt % polymerized acid monomer; and
a second polymer layer encapsulating the first polymer layer or the pigment,
wherein the second polymer layer is more hydrophilic than the first polymer layer,
wherein the encapsulated pigment has a particle size less than about 500 nm.

2. An encapsulated pigment as in claim 1, wherein the weight ratio of the first polymer layer to the second polymer layer is greater than about 1.5:1.

3. An encapsulated pigment as in claim 1, where in the first polymer layer is substantially free of acid.

4. An encapsulated pigment as in claim 1, wherein the first polymer layer substantially encapsulates the pigment, and the second polymer layer substantially encapsulates the first polymer layer.

5. An encapsulated pigment as in claim 1, wherein the encapsulated pigment has a second polymer layer with at least 2 wt % polymerized acid monomer.

6. An encapsulated pigment as in claim 1, wherein the encapsulated pigment has a second polymer layer with greater than about 5 wt % polymerized acid monomer.

7. An encapsulated pigment as in claim 1, wherein the encapsulated pigment has a second polymer layer with greater than about 8 wt % polymerized acid monomer.

8. An encapsulated pigment as in claim 1, wherein the first polymer layer has a T_{g} less than a T_{g} of the second polymer layer.

9. An encapsulated pigment as in claim 8, wherein the T_{g} of the first polymer layer is from about −25° C. to about 105° C.

10. An encapsulated pigment as in claim 1, wherein the first polymer layer includes cross-linking.

11. An encapsulated pigment as in claim 1, further comprising a third polymer layer substantially encapsulating the second polymer layer.

12. An encapsulated pigment as in claim 1, wherein the encapsulated pigment has a particle size less than about 300 nm.

13. An ink-jet ink, comprising a plurality of encapsulated pigments as in claim 1 dispersed in a liquid vehicle.

14. An ink-jet ink as in claim 13, wherein the ink-jet ink is formulated for use in thermal ink-jet architecture.

15. A method of making an encapsulated pigment, comprising:
dispersing a pigment in an aqueous medium;
polymerizing a plurality of first-layer monomers in the aqueous medium by initiating polymerization of the first-layer monomers to create a first polymer layer encapsulating the pigment, wherein the first-layer monomers include less than 2 wt % of acidic monomers;
dispersing a plurality of second-layer monomers in the aqueous medium, wherein the second-layer monomers include at least one monomer that is compositionally different from the first-layer monomers, wherein the second-layer monomers include at least 2 wt % of acidic monomers; and
polymerizing the plurality of second-layer monomers on a surface of the first polymer layer to create a second polymer layer encapsulating the pigment and the first polymer layer.

16. A method as in claim 15, wherein the pigment is uncharged.

17. A method as in claim 15, wherein the first-layer monomers are substantially free of acid.

18. A method as in claim 15, wherein the second-layer monomers include a monomer selected from the group consisting of hydroxyethylacrylate, hydroxylethyl methacrylate, acrylamides, and combinations thereof.

19. A method as in claim 15, further comprising the steps of dispersing a plurality of third-layer monomers in the aqueous medium, wherein the third-layer monomers are compositionally different from the second-layer monomers, and polymerizing the plurality of third-layer monomers on a surface of the second polymer layer to create a third polymer layer substantially encapsulating the pigment, the first polymer layer, and the second polymer layer.

20. A method as in claim 15, wherein the aqueous medium contains less than 2 wt % polymeric acid in the aqueous medium after the encapsulated pigment is formed.

21. A method of making an encapsulated pigment, comprising:
dispersing a pigment in an aqueous medium;
polymerizing a plurality of second-layer monomers in the aqueous medium by initiating polymerization of the second-layer monomers to create a second polymer layer encapsulating the pigment;
dispersing an inner composition in the aqueous medium, wherein the inner composition is substantially hydrophobic as compared to the second composition;
providing conditions configured to encourage migration of the inner composition through the second polymer layer.

22. A method as in claim 21, wherein the migration is facilitated by kinetic or thermodynamic mechanisms.
